(19) United States
(12) Patent Application Publication
(10) Pub. No.: US 2016/0253527 A1
(43) Pub. Date: Sep. 1, 2016

(54) SECURE DATA ENTRY DEVICE

(71) Applicant: POWA TECHNOLOGIES LIMITED, London (GB)

(72) Inventors: Steve MCFALL, London (GB); Dan WAGNER, (GB)

(21) Appl. No.: 15/027,207

(22) PCT Filed: Oct. 2, 2014
(86) PCT No.: PCT/GB2014/052988

§ 371 Date: Apr. 4, 2016

(30) Foreign Application Priority Data
Oct. 2, 2013 (GB) 1317466.9

(51) Int. Cl. G06F 21/83; G07C 9/00; G06F 21/86

(52) U.S. Cl. CPC G06F 21/83; G06F 21/86; G07C 9/00007; G07C 9/00142

(57) ABSTRACT

A secure data entry device with a data input device, such as a keypad (18), a reader for reading a removable data medium, such as an ICC, electronic circuitry, and a security frame. The data input device, reader and security frame forming a security cage around the electronic circuitry that assists in securing the electronic circuitry from unauthorised access and/or tampering.

### FIELD OF THE DISCLOSURE

The present disclosure relates to a secure data entry device. It also relates to a system comprising the secure data entry device.

### BACKGROUND

Data entry devices are employed in many situations and it is a common requirement that they are secure. Accordingly, secure data entry devices are available that resist unauthorised access to the internal circuitry of the data entry device, especially the circuitry that processes or stores sensitive information.

An example of a data entry device that is required to be secure is a personal identification number (PIN) entry device (PED). PEDs are used to process payments securely. Such devices have a keypad for the customer to input their PIN along with internal circuitry which encrypts the customer's information for external transmission. Therefore, it is of the upmost importance that the circuitry within the PED that carries sensitive information is secure from external attack. This is recognised by the existence of security standards for such devices administered by the PCI Security Standards Council. Previous secure data entry devices have used a security mesh to enclose and protect sensitive circuitry.

### SUMMARY OF THE DISCLOSURE

The present disclosure relates to arrangements that improve the security for sensitive electronic circuitry without resorting to complex and elaborate approaches.

In a first aspect of the present disclosure, there is provided a secure data entry device comprising a data input device; electronic circuitry; and a security frame, wherein the data input device and the security frame are arranged to form a security cage for substantially surrounding the electronic circuitry.

The secure data entry device may further comprise a reader. Such a reader could be a biometric unit, for example a fingerprint reader. Preferably, the reader is a reader for reading a removable data medium. The reader and the security frame may be together arranged to form the security cage for substantially surrounding the electronic circuitry.

As stated above, the security cage may be formed from the data input device, the reader and the security frame. Using the data input device and the reader as part of the security cage minimises the requirement for additional security-specific components and thus allows the secure data entry device to maintain a small form factor. This can improve the portability of the secure data entry device without sacrificing security.

A secure data entry device is a device that is used for receiving data input and has security measures that help to protect data from unauthorised access and/or protect the device from tampering.

The data input device is the device that allows the user to enter data. The data input device has a user-facing component with which the user will directly interact, as well as additional mechanisms that convert the user's interactions into a data signal that can be used by the secure data entry device. Such mechanisms can include electrical contacts which are closed when a user presses a given point on the data input device.

Possible data input devices that may be used with the present disclosure include a keypad. The keypad may have a plurality of keys allowing the user to input data in the form of a combination of key presses. The keypad may have at least ten keys so as to allow the input of any combination of Arabic numerals. Alternatively, or in addition, the data input device may have sufficient keys to represent all the letters of an alphabet, for example all 26 letters of the English alphabet. The keypad of a data input device may have at least twelve keys, preferably at least sixteen keys. The keypad may have twelve keys or sixteen keys.

The reader may be capable of reading a removable data medium. This allows the secure data entry device to read information from the removable data medium, which in turn can influence any subsequent processing or action of the secure data entry device. For example, the reader allows the secure data entry device to cross-check a code inputted by the user on a data input device with a code stored on the removable data medium. The information read from the removable medium may be processed in the electronic circuitry.

The removable data medium may be a secure card and, correspondingly, the reader may be a secure card reader for receiving the secure card. Such a secure card may be an integrated circuit card (ICC) and, in this case, the reader is an ICC reader. An ICC is a form of card used, among other things, for chip and PIN payment. Alternatively, the removable data medium may be a near field communication (NFC) card and the reader is a NFC reader.

The secure data entry device includes electronic circuitry. The electronic circuitry processes data from the data input device as well as possible data read by a reader from a removable data medium. The electronic circuitry may therefore be processing security-sensitive information requiring protection from unauthorised access by a security cage, as described later. The electronic circuitry may be present on a printed circuit board (PCB). The electronic circuitry may include components which are security-sensitive.

The security frame protects the electronic circuitry within it from attack from certain directions. In this way it contributes to the secure nature of the secure data entry device.

The security frame may comprise a continuous frame structure around a hollow centre in which the electronic circuitry is located. This advantageously provides a continuous form of protection in certain areas around the electronic circuitry. The security frame may be a planar structure that has a relatively small through-thickness dimension compared to a relatively large width and length dimension. Such relative dimensions allow the secure data entry device to maintain a small form factor. In this way, the security frame completely protects the electronic circuitry from attack within the plane of the frame.

As stated above, the data input device, the reader and the security frame can be arranged to form a security cage. Therefore, these three components are arranged so that each of them represents a barrier to accessing the electronic circuitry. In this way, each of these components is contributing to the security of the electronic circuitry and so advantageously increasing the difficulty of unauthorised access. These components substantially surround the electronic circuitry. In other words, there may be additional components present which further contribute to enclosing the electronic circuitry but each of the data input device and the security frame, as well as the reader if present, are arranged such that they all contribute to the enclosing of the electronic circuitry. Another component that may possibly contribute to surrounding the electronic circuitry is a security mesh, as will be described below.

The data input device is preferably arranged to be a first side of the security cage. The reader is preferably arranged to be a second side of the security cage. The security frame is preferably arranged between the data input device and the reader. Using the data input device as one side of the security cage and/or the reader as a second side of the security cage utilises these components to increase the protection of the electronic circuitry within the security cage from attack from these sides. Positioning the security frame between the data input device and the reader results in the data input device providing protection from one side, the reader providing protection from another side and the security frame providing protection for other sides around the electronic circuitry. In this way, these three components can provide complete, or almost complete, protection for the electronic circuitry.

The security frame may have further features to prevent or detect tampering attempts, i.e. attempts to access or manipulate the circuitry contained within the security frame. One such feature is the presence of conductive vias. The security frame, which has a first side and a second side, may have at least one conductive via extending between the first side and the second side. If unauthorised physical access is attempted through the part of the security frame that has a via present then the conductive via will be broken and a tamper event can be registered. The registering of the tamper event can result in the sounding of an alarm, or the deletion of sensitive data from the electronic circuitry contained within the security cage.

It is particularly preferred that there is a plurality of conductive vias present so as to allow the registration of a tamper event from any of a number of different directions. An increased number of vias, decreases the possibility that the intrusion attempt won't disrupt a via or won't cause sufficient disruption to the via to register a tamper event.

When the security frame is in the form of a planar structure it is preferred that the first side and the second side are the first planar face and the second planar face resulting in the conductive vias extending through the thickness of the security frame.

It is particularly preferred that the at least one via is formed along the inner edge of the security frame, adjacent to the hollow centre of the security frame. The inner edge of the security frame is the face, or faces, of the security frame that face the hollow centre of the security frame. When the security frame has a planar structure, the inner edge is the exposed face that spans the through-thickness direction of the security frame and faces the hollow centre. The at least one via may be exposed along the inner edge of the security frame. In other words, the conductive via can be completely seen from a viewpoint at the hollow centre of the security frame. This places the conductive via as close to the security sensitive electronic circuitry as possible.

The at least one via may be formed as a hole through the security frame. This hole can have conductive material coated on its inner surface to result in a through-thickness conductive trace. Such a hole can be cut in half so as to expose the conductive trace from a viewpoint at the hollow centre. This is a particularly straightforward way of producing exposed vias along the inner edge which utilises common electronics processing steps.

The security frame may have conductive vias for carrying data. These vias may form a conductive path from outside the security frame to carry data to devices positioned within the hollow centre of the security cage. Vias for carrying data and vias for detecting tampering events may both be present.

The security frame may be formed from a printed circuit board material. A printed circuit board material is one that is commonly used as a printed circuit board. Such materials are laminates that are manufactured by curing thermoset resin under pressure and temperature with layers of cloth or paper. Examples of laminates that are used as printed circuit board material are FR-2, FR-3, FR-4, FR-5, FR-6, G-10, CM-1, CM-2, CM-3, CM-4, CM-5. Preferably the PCB material is FR-4 since this is particularly readily available as one of the most common PCB materials. FR-4 refers to a PCB material with glass reinforced epoxy laminate sheets composed of woven fibre glass cloth with an epoxy resin binder.

Utilising printed circuit board material as a security frame is an advantageously straightforward approach for manufacturing the security frames of the present disclosure, allowing the use of existing, well-established manufacturing technology. It also negates the need for specialist materials, since it is possible to utilise the same PCB material that is used for the electronic circuitry that is to be protected. Additionally, the use of PCB material for the security frame allows the straightforward production of the anti-tamper vias as described above.

The security frame is preferably affixed into position using solder joints. When the security frame comprises at least one conductive via, the positioning of the solder joints may correspond to the conductive vias present. This provides a continuous conductive path through the security cage to the component to which the security frame is affixed. These conductive paths can be used to transmit data though the security cage. In addition, or alternatively, these conductive paths are part of a tamper detection system. If the solder joint is broken, either by moving of the security cage or by direct physical intervention, a tamper event can then be registered.

The use of solder to affix the security frame also allows the affixing step to be carried out as part of standard PCB processing, increasing the ease of manufacture.

The security cage may comprise at least one layer of security mesh. The security mesh provides extra protection against unauthorised access to the electronic circuitry. The security mesh may be conductive. When the security mesh is conductive, it may be connected to additional circuitry that can detect when the mesh's conductivity is disrupted and so register a tamper event. This provides additional security for the electronic circuitry in the security cage. When a ‘security mesh’ is used herein, an additional security layer could alternatively be used which functions to increase the security of the device but does not have a form reminiscent of a mesh.

The security mesh may be made from wire. In particular, the security mesh may be made from metallic wire. The wire may be a fine wire, i.e. less than about 0.2 mm in thickness. Also, the individual wires may be spaced no more than about 0.2 mm apart.

The security mesh may be in the form of conductive traces on a substrate. Traces of the security mesh may be 0.17 mm or less in width and/or spaced 0.17 mm or less apart. It is found that this width and spacing provides a high level of security for the underlying components. The security mesh substantially covers the regions of the substrate for which protection is desired. The traces may overlap and/or connect with each other. The traces may be in the form of lines that extend for a variety of distances in a plurality of directions. In particular, the traces may comprise regions where the traces run substantially parallel. It is preferred that the traces do not possess any long range order, i.e. it is preferred that the traces do not have a repeating pattern. The absence of such order increases security by minimising the possibility of predicting the location of the traces.

The security mesh utilised may be chosen to meet the required security standards, such as the Payment Card Industry PIN Transaction Security (PCI PTS) standard.

A security mesh that forms part of the security cage may be positioned in various locations in order to provide additional protection for the electronic circuitry. For example, the security mesh may be positioned over the outer surface of the data input device. The outer surface of the data input device is the surface that is not facing the electronic circuitry that is inside the security cage. In this position the security mesh provides a level of protection before any attack would then need to overcome the barrier of the data input device.

A security mesh may be positioned over the outer surface of the reader. The outer surface of the reader is the surface that does not face the electronic circuitry that is within the cage. Again, this security mesh provides another layer of initial protection for the electronic circuitry within the security cage.

A layer of security mesh may be positioned between the inner surface of the data input device and the inner surface of the reader. Such positioning of a security mesh provides another layer of protection for the electronic circuitry after the data input device or the reader may be breached. The security mesh may be either side of the electronic circuitry. Alternatively, a security mesh could be positioned on both sides of the electronic circuitry but on the inside of the data input device and the reader, i.e. within the security cage.

A security mesh may be positioned within the data input device. In particular, the security mesh may be positioned under a user-facing layer, with which the user directly interacts, but above the additional operating mechanisms of the data input device. This has the benefit of also providing a layer of security for the mechanism of the data entry device without interrupting the user's experience of the data entry device.

The security mesh may be present between or within layers of components of the secure data entry device. For example, the substrate that contains the electronic circuitry, e.g. the PCB, may be formed from a plurality of layers and the security mesh, particularly in the form of conductive traces, may be formed on or within one or more of these layers. This provides further protection by registering any tampering event that disrupts a conductive trace. It is particularly desirable to provide security mesh on one or more layers of the substrate so that a security mesh is present on one or both sides of the substrate layers that route security sensitive signals, such as data input signals or signals read from a removable data medium. In this way, layers of the substrate that route such sensitive signals can be closely protected by security mesh on neighbouring layers. Any such layered components may comprise a first planar surface and a second planar surface. The first and second planar surfaces may be opposing external surfaces of the layered component that extend substantially parallel to the major faces of the layers. A security mesh can be provided on or within the first, second, third, fourth and/or further layer, where the first planar surface is a surface of the first layer of the layered component and the other layers are numbered consecutively away from the first layer. Alternatively or additionally, a security mesh can be provided on or within the first, second, third, fourth and/or further layer from the second planar surface, where the second planar surface is a surface of the first layer of the layered component and the other layers are numbered consecutively away from the first layer. For example, a security mesh can be provided on or within the second layer relative to the first planar surface and/or the second layer relative to the second planar surface. The layered component may comprise eight layers and a security mesh may be provided on or within the second and/or seventh layers relative to the first planar surface and/or the second planar surface.

In a similar way, a security frame may also be formed from a plurality of layers. One or more of these layers may have a security mesh (as described herein), particularly in the form of conductive traces, formed thereon or within the layer(s). Again, this provides added security within the security frame and assists in registering tamper events that disrupt the security mesh.

It is obviously possible for several layers of security mesh to be present at one or more of the positions stated above. A greater number of layers of security mesh will increase the security of the device but will add to the cost and complexity of manufacture.

The secure data entry device may be a personal identification number (PIN) entry device (PED). It is particularly important that such devices have a secure location within them for the electronic circuitry that stores and processes sensitive information such as user's PINs and account numbers. This importance is emphasised by the existence of security standards which such PEDs must fulfil, such as the PCI PTS certification.

The secure data entry device may further comprise tamper switches so as to detect separation of the various components of the secure data entry device. Tamper switches may be present between the security frame and the substrate on which the electronic circuitry is formed and/or between the security frame and the reader for reading a removable data medium (if present) and/or the data input device and the substrate on which the electronic circuitry is formed, or any other locations between two adjoining components. The tamper switch may have two contacts which are in electrical communication when the relevant components are in their correct position, the electrical communication being disrupted when the components are separated, in this way separation of the relevant components can be detected. The tamper switches may further comprise a third contact which is not in electrical communication with the other two contacts. If an attempted tampering event involves the application of a conductive medium so as to avoid breaking the electrical connection between the two contacts, the third contact will be put into electrical communication with the other two contacts and this change in conductivity can be detected and a tamper event registered.

When referring to a PCB herein, it will be appreciated that another substrate may be used in place of the PCB as long as it is capable of supporting electronic components and connections.

The present disclosure also provides a security frame formed from a printed circuit board (PCB) material, comprising a continuous frame structure with a hollow centre, wherein the continuous frame structure has a first side and a second side; and at least one conductive via extending between the first side of the frame structure and the second side of the frame structure.

As noted above, such a security frame provides extra security for anything present in its hollow centre. In particular, the printed circuit board continuous frame provides a physical barrier for accessing the hollow centre from a range of directions. Also, the presence of at least one conductive via provides a trace that may be broken in any unauthorised access attempt. This disruption of the via can then be used to register a tamper event. The features recited above with reference to the security frame present as part of a secure data entry device apply equally to the security frame in isolation from the rest of the secure data entry device.

The security frame of the present invention can be utilised in a range of scenarios. In the above-noted application of a secure data entry device, the security frame forms a security cage with a data input device and, optionally, a reader. However, the security frame can be utilised with other components to form a security cage. In one of its simplest forms, a security cage can be formed by sandwiching the security cage between two PCBs.

The present disclosure also provides a PCB assembly comprising security-sensitive components on a PCB; and a security frame according to the present disclosure, wherein the security frame is affixed around the security-sensitive components. Securing the security frame around security-sensitive components on a PCB provides the protection highlighted above for those security-sensitive components.

The security frame can be affixed by adhesive. Alternatively, the security frame may be affixed by using a screw connection or by using rivets. Preferably, the security frame is affixed to by using solder joints. The solder joints may correspond to vias present in the security frame providing a continuous conductive path through the security frame and into the component to which the security frame is affixed. As noted above, this has advantages for carrying data and providing tamper protection.

The present disclosure further provides a system comprising the secure data entry device according to the present disclosure; and a communication device; wherein the secure data entry device and the communications device are configured to communicate with each other.

Such a system allows the secure data entry device to be of a minimal size as the communications device can contain the additional components that do not need to be part of the secure data entry device.

The communication device may be configured to communicate with an external system. The communication device may be a mobile communications device, such as a smart phone. The mobile communication device may run an application that drives the communications required to connect to an external system. The secure data entry device and the communication device may communicate with each other via Bluetooth technology. Accordingly, the secure data entry device of the present disclosure may comprise a Bluetooth module. Also, the communication device may comprise a Bluetooth module.

The external system may be a payment acquirer. A payment acquirer is an entity that processes card-based payments.

### BRIEF DESCRIPTION OF THE DRAWINGS

The invention is described below, by way of example only, with reference to the accompanying drawings, in which:

FIG. 1 is a perspective view of a PCB assembly with a security frame;

FIG. 2 is a perspective view of the PCB assembly of FIG. 1 with a security mesh layer;

FIG. 3 is a perspective view of a PCB assembly of FIG. 2 with an ICC reader;

FIG. 4 is a perspective view of the PCB assembly of FIG. 3 with an additional security mesh layer on top of the ICC reader; and

FIG. 5 is a perspective view of key-press detection components on the reverse side of the PCB assembly of FIGS. 1 to 4.

FIG. 6 is a cross-sectional view of the main PCB depicted in FIGS. 1 to 5.

FIG. 7 is a plan view of the security mesh of layer 2 in FIG. 6.

FIG. 8 is a cross-sectional view of the security frame depicted in FIGS. 1 and 2.

FIG. 9 is a plan view of the security mesh of layer 2 in FIG. 8.

### DETAILED DESCRIPTION

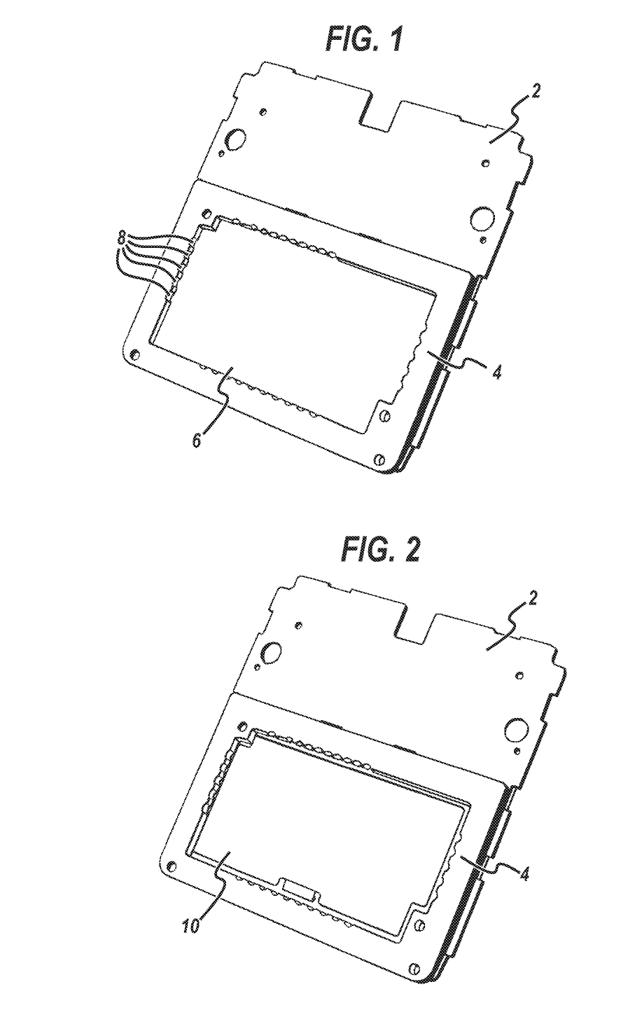

FIGS. 1 to 9 illustrate various security features provided by the present invention.

FIG. 1 depicts a main PCB 2 with a security frame 4 affixed thereto. The security frame 4 is planar in structure having a length and width which are significantly larger than the thickness dimension. The security frame 4 has a hollow centre 6 within which security-sensitive electronic circuitry (not shown) is located and mounted on the PCB. The security frame 4 protects the electronic circuitry from attack from the sides, i.e. attacks that have a direction within the plane of the security frame 4. Such attacks include possible probing with conductive probes in an attempt to access the electronic circuitry. In this regard, the frame is particularly suitable since, for example, it prevents side attacks against the pins of integrated circuits making up the electronic circuitry.

The security frame 4 is not positioned around the entire PCB 2, but only surrounds security-sensitive electronic components, and is thus mounted only on a sub-section of the PCB where the security-sensitive components are located. Other non-security sensitive electronic components (not shown) can be located on the PCB external to the security frame 4.

The security frame 4 has a plurality of vias 8 around its inner edge. These vias 8 are in the form of half through-holes resulting in the via being exposed to a viewpoint at the hollow centre 6 of the security frame 4.

FIG. 2 illustrates the same view as FIG. 1, but with the addition of a layer of security mesh 10 in the hollow centre 6 of the security frame 4. The security mesh 10 is positioned over the electronic circuitry that is present in the hollow centre 6 of the security frame 4.

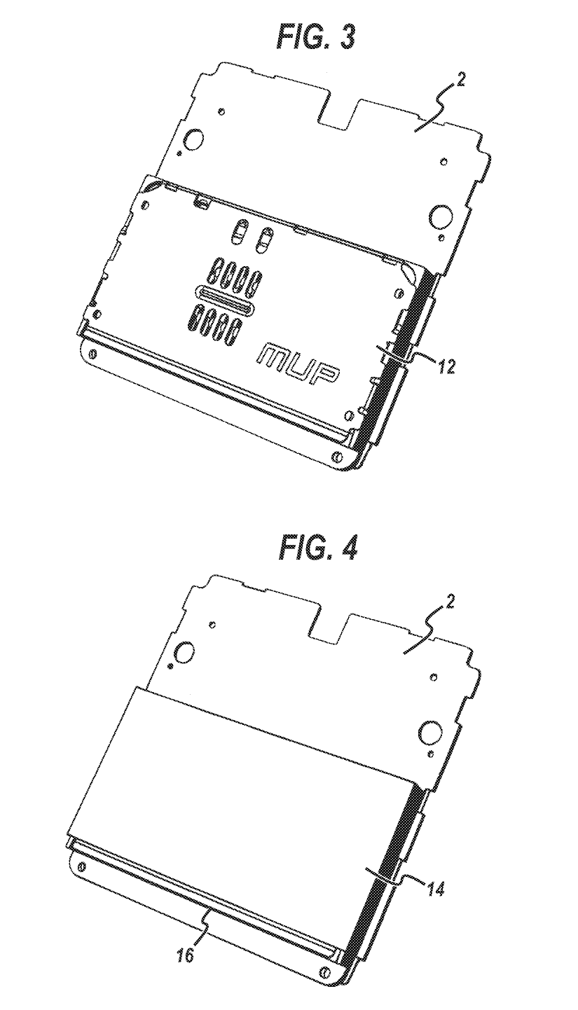

FIG. 3 illustrates a PCB assembly as depicted in FIG. 2 but with the addition of an ICC reader 12 on top of security frame 4. The ICC reader 12 therefore represents a further physical barrier to any attack attempting to reach the electronic circuitry beneath. The ICC reader 12 is further covered with another security mesh 14, as illustrated in FIG. 4. Security mesh 14 is positioned to cover the major outer face of the ICC reader 12 and the edges, apart from the lower edge 16 which is left clear for the insertion and removal of ICCs.

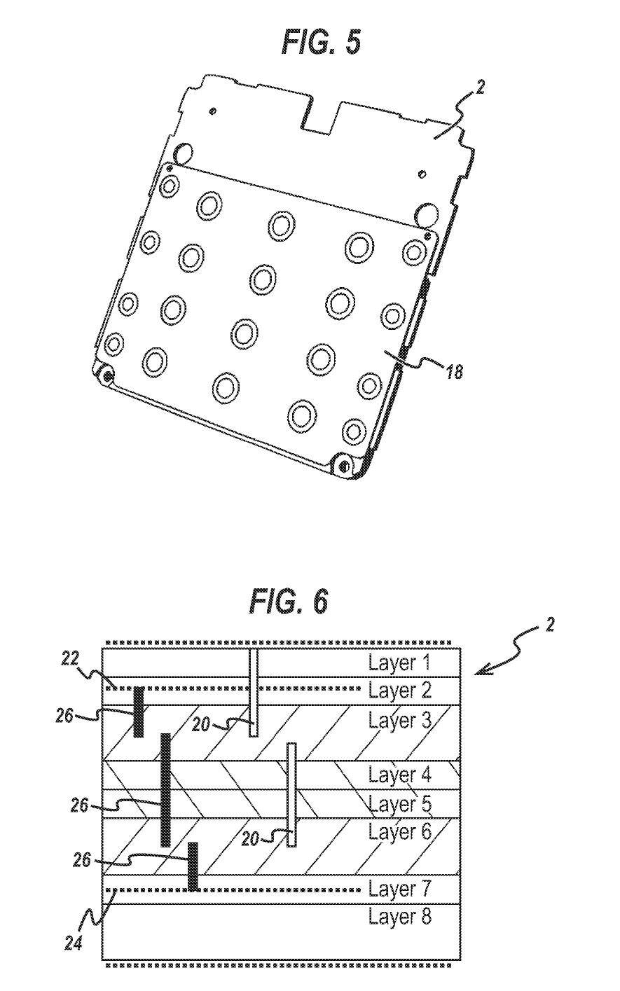

The other side of the main PCB 2 has a key-press detection component 18 for detecting button presses via a keypad (not shown) affixed thereto as illustrated in FIG. 5. Therefore, the ICC reader 12, the security frame 4 and the keypad 18 substantially surround the security-sensitive electronic circuitry that is present in the hollow centre 6 of the security frame 4. In this way, attack from any one side is resisted by the presence of key-press detection component 18, attack from the other side is resisted by the presence of ICC reader 12, and attack from the remaining edges is resisted by the presence of security frame 4.

The main PCB 2 is formed from a stack of 8 layers. A cross-section of the main PCB is depicted in FIG. 6. The keypad signals 20 are primarily routed within layers 3, 4, 5 and 6. Security meshes 22, 24 are provided within layers 2 and 7 in the form of conductive traces so as to provide additional security to the layers primarily used for routing sensitive signals. The security mesh signals 26 are also routed between layer 2 and layer 7.

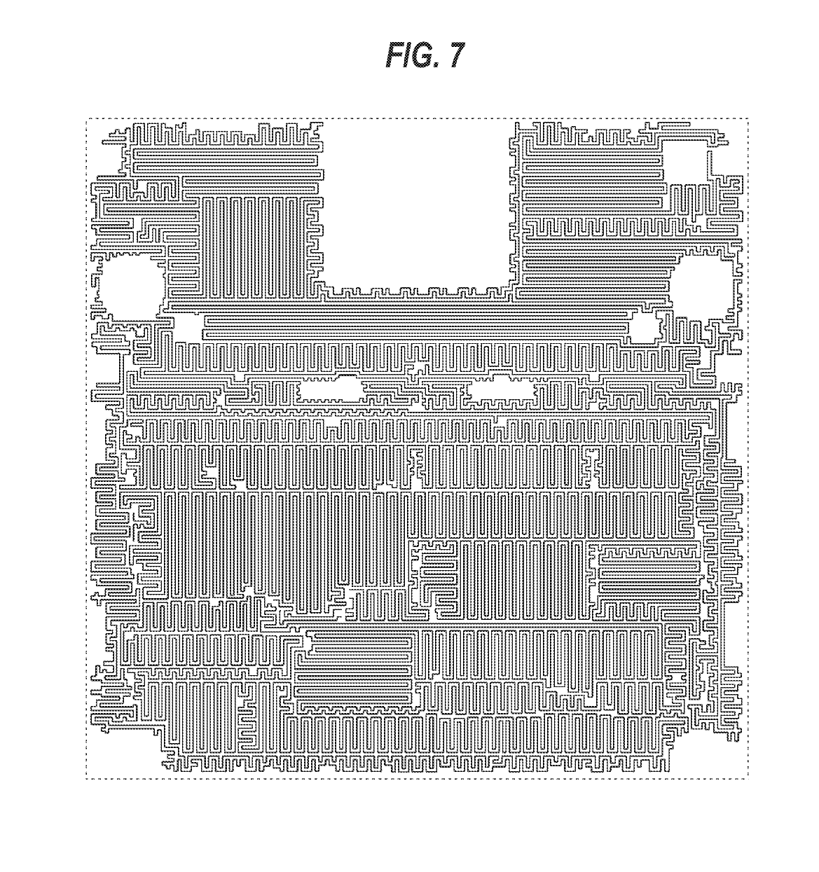

The form of the conductive trace present within layer 2 of the main PCB 2 is depicted in FIG. 7. It can be seen here that the traces run parallel over short distances but there is no long range order to the arrangement.

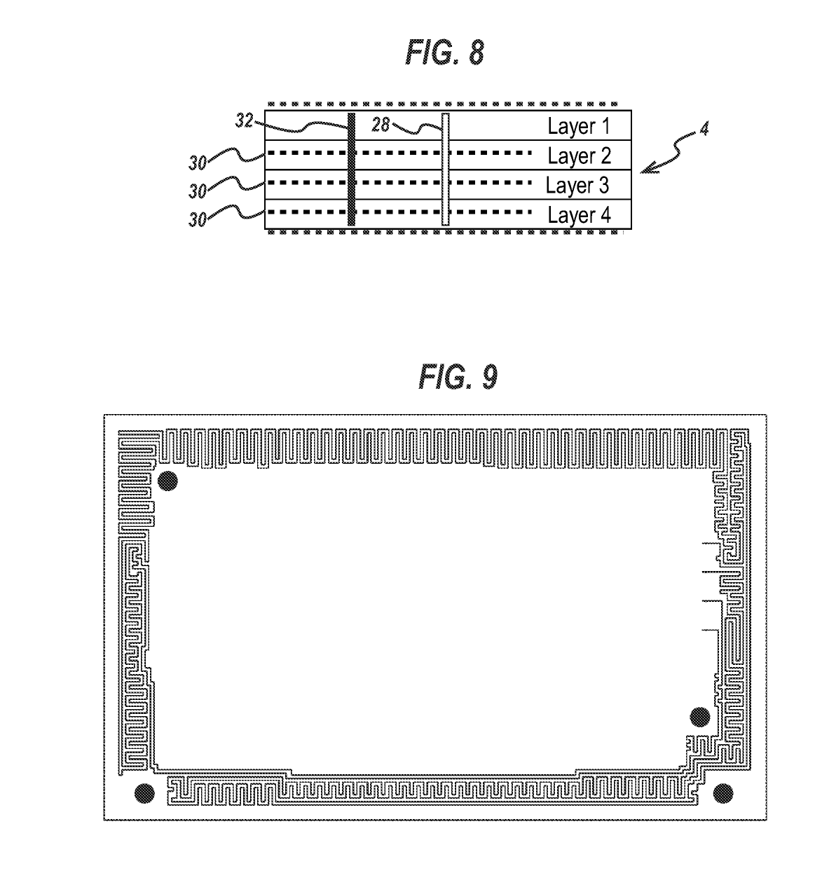

The security frame 4 is constructed from a stack of 4 layers. A cross-section of the security frame 4 is depicted in FIG. 8. ICC signal 28 is routed across the security frame and security meshes 30 are present in layers 2, 3 and 4 in the form of conductive traces providing additional security. The security mesh signal 32 is also routed through these layers.

The form of the conductive traces present within layer 2 of the security frame 4 is depicted in FIG. 9. The traces are arranged as parallel lines but there is no long range order to the arrangement.

The present invention has been described above in exemplary form with reference to the accompanying drawings which represent embodiments of the invention. It will be understood that many different embodiments of the invention exist, and that these embodiments all fall within the scope of the invention as defined by the following claims.

1. A secure data entry device comprising
a data input device;
electronic circuitry; and
a security frame,
wherein the data input device and the security frame are arranged to form a security cage for substantially surrounding the electronic circuitry.

2. The secure data entry device of claim 1, further comprising a reader for reading a removable data medium, wherein the reader is arranged to form part of the security cage.

3. The secure data entry device of claim 2, wherein:
the data input device is arranged to be a first side of the security cage;
the reader is arranged to be a second side of the security cage; and
the security frame is arranged between the data input device and the reader.

4. The secure data entry device of any one of claims 1 to 3, wherein the security frame comprises a continuous frame structure around a hollow centre in which the electronic circuitry is located.

5. The secure data entry device of claim 4, wherein the security frame has a first side and a second side and further comprises at least one conductive via extending between the first side and the second side.

6. The secure data entry device of claim 5, wherein the at least one via is formed along the inner edge of the security frame, adjacent to the hollow centre.

7. The secure data entry device of any preceding claim, wherein the security cage further comprises at least one layer of security mesh.

8. The secure data entry device of claim 7, wherein a security mesh is positioned over the outer surface of the data input device.

9. The secure data entry device of claim 7 or claim 8 when dependent on claim 2, wherein a security mesh is positioned over the outer surface of the reader.

10. The secure data entry device of any one of claims 7 to 9 when dependent on claim 2, wherein a security mesh is positioned between the inner surface of the data input device and the inner surface of the reader.

11. The secure data entry device of any one of claims 7 to 10, wherein a security mesh is positioned within the data input device.

12. The secure data entry device according to any preceding claim, wherein the data input device is a keypad.

13. The secure data entry device according to any one of claim 2 or 3, or claims 4 to 12 when dependent on claim 2, wherein the reader is a secure card reader for receiving a secure card.

14. The secure data entry device according to any preceding claim, wherein the secure data entry device is a personal identification number (PIN) entry device (PED).

15. A security frame formed from a printed circuit board (PCB) material, comprising
a continuous frame structure with a hollow centre, wherein the continuous frame structure has a first side and a second side; and
at least one conductive via extending between the first side of the frame structure and the second side of the frame structure.

16. The security frame according to claim 15, wherein the at least one via is formed along the inner edge of the frame structure, adjacent the hollow centre.

17. A printed circuit board (PCB) assembly comprising:
security-sensitive components on a PCB; and
the security frame according to claim 15 or claim 16, wherein the security frame is affixed around the security-sensitive components.

18. A system comprising
the secure data entry device according to any one of claims 1 to 14; and
a communications device;
wherein the secure data entry device and the communications device are configured to communicate with each other.

19. The system according to claim 18, wherein the communications device is configured to communicate with an external system.

20. The system according to claim 19, wherein the external system is a payment acquirer.

21. A secure data entry device as hereinbefore described with reference to the accompanying drawings.

22. A security frame as hereinbefore described with reference to the accompanying drawings.

23. A system as hereinbefore described with reference to the accompanying drawings.
